(19) United States
(12) Patent Application Publication
(10) Pub. No.: US 2026/0116124 A1
(43) Pub. Date: Apr. 30, 2026

(54) CASTER FOR CARRIER

(71) Applicants: Ji Yeong PARK, Seoul (KR); Bo Yeong PARK, Seoul (KR); Chae Yeong PARK, Seoul (KR)

(72) Inventors: Ji Yeong PARK, Seoul (KR); Bo Yeong PARK, Seoul (KR); Chae Yeong PARK, Seoul (KR)

(21) Appl. No.: 17/256,113

(22) PCT Filed: Oct. 21, 2020
(86) PCT No.: PCT/KR2020/014421

§ 371 Date: Mar. 10, 2025

(30) Foreign Application Priority Data
May 15, 2020 (KR) 10-2020-0058348

(51) Int. Cl. B60B 33/00; A45C 5/14

(52) U.S. Cl. CPC B60B 33/0086; A45C 5/145; B60B 33/0042; B60B 2200/45; B60B 2900/531

(57) ABSTRACT

A caster for a carrier for a carrier mounted on a lower surface of a carrier receiving part, includes: a base part mounted on a lower surface of the carrier receiving part; a body rotatably mounted on the base part based on a rotation shaft; a wheel mounted on the body; a restraining part mounted on the body and selectively restraining the wheel by pressing by the base part rotated when pressing the carrier receiving part down or inclining the carrier receiving part; and a first restoration spring provided between the base part and the body to restore the rotated base part to its original position, where a first shaft mounting hole in which the rotation shaft is mounted is formed in one side of the body and a fixing hole is formed in an upper surface of the other side of the body.

### BACKGROUND

The present invention relates to a caster for a carrier, and more particularly, to a caster capable of more easily operating a caster and further more easily handling a carrier receiving part by simply pressing the carrier receiving part with a hand or inclining the carrier receiving part to press a restraining part of the caster so as to selectively drive a driving mode or a stop mode of the caster, without pressing a lever installed around the wheel with a foot or removing the wheel itself from the carrier to control a rolling condition of the wheel.

In general, a bag is a device manufactured to put goods and easily carry the goods, and the type thereof is very various according to a portable type, a shape, a size, a structure, etc. The bags may be classified into handbags carried by hand, backpacks carried on the shoulders, and carriers (travel bags) carried by using wheels on the road surface according to a portable type.

In particular, the carriers generally have a wide storage space and have casters, so as to be easy to move while traveling and be very useful when storing goods.

The caster mounted on the carrier is configured to be freely rolled from the floor for the convenience of moving the carrier, and when the caster is easily rolled, the carrier may freely move during the carrier handling process, such as missing the carrier for unforeseen reasons or stopping the carrier, to cause safety problems such as collision around the carrier.

For this reason, most casters are equipped with a locking means to limit the rolling of the casters.

As the related art of the caster with the locking means, there is disclosed in Korean Patent Publication No. 10-2016-0074311.

The related art limits a technique to enable locking and unlocking with a simple operation on the wheel, but when locking and unlocking, a user needs to press a locking pedal directly with a foot, and thus, when the wheels are turned or the wheels are hidden in a carrier receiving part, etc., the locking pedal cannot be easily operated, such as pushing the foot deep to press the locking pedal, and the like. In some cases, while the lock pedal is pressed with one foot, the other foot loses its balance to cause a safety problem.

Patent Document 1: Korean Laid-open Patent Publication No. 10-2016-0074311

### SUMMARY OF THE INVENTION

The present invention is derived to solve the problems of the related art, and an object of the present invention is to provide a caster capable of more easily operating the caster and further more easily handling a carrier receiving part by simply pressing the carrier receiving part with a hand or inclining the carrier receiving part to press a restraining part of the caster so as to selectively drive a driving mode or a stop mode of the caster, without pressing a lever installed around the wheel with a foot or removing the wheel itself from the carrier to control a rolling condition of the wheel.

The present invention provides a caster for a carrier mounted on a lower surface of a carrier receiving part as a means to achieve the object, the caster may comprise a base part mounted on a lower surface of the carrier receiving part; a body rotatably mounted on the base part based on a rotation shaft; a wheel mounted on the body; a restraining part mounted on the body and selectively restraining the wheel by pressing by the base part rotated when pressing the carrier receiving part down or inclining the carrier receiving part; and a first restoration spring provided between the base part and the body to restore the rotated base part to its original position.

Further, a first shaft mounting hole in which the rotation shaft is mounted may be formed in one side of the body, a fixing hole in which the restraining part is mounted may be formed through an upper surface of the other side of the body in upper and lower directions, and a spring mounting groove in which a lower portion of the first restoration spring is received may be depressed and formed on the upper surface between the first shaft mounting hole and the fixing hole.

The restraining part may comprise a cylinder fixedly mounted in the fixing hole and having guide grooves formed in upper and lower directions on an inner circumferential surface thereof and first locking teeth formed at a lower end thereof; a push rod which reciprocates upward and downward from the inside of the cylinder while exposed to the upper portion of the cylinder and has second locking teeth formed at a lower end thereof; an operation shaft including an insertion shaft inserted into the push rod and a cam shaft which extends to the lower portion of the insertion shaft and has an operation cam protruding from the outer circumferential surface thereof to be engaged with the first locking teeth or inserted into the guide grooves; a restraint plate which is mounted on the lower end of the operation shaft and configured to be selectively locked to the wheel by elevating upward and downward in the operation space by the operation shaft; and a second restoration spring which is provided in the operation space to elastically press the restraint plate upward.

Further, a plurality of spokes may be formed at equal intervals on an inner ring of the wheel and the restraint plate may have a locking protrusion protruding to be selectively inserted into a point between adjacent spokes.

In the lower portion of the fixing hole, an operation space for lifting a restraint plate may be formed.

The present invention provides effects capable of more easily operating a caster and further more easily handling a carrier receiving part by simply pressing the carrier receiving part with a hand or inclining the carrier receiving part to press a restraining part of the caster so as to selectively drive a driving mode or a stop mode of the caster, without pressing a lever installed around the wheel with a foot or removing the wheel itself from the carrier to control a rolling condition of the wheel.

### BRIEF DESCRIPTION OF DRAWINGS

FIG. 1 is a diagram illustrating an example of a caster mounted on a carrier.

FIGS. 2 to 3 are diagrams illustrating the overall appearance of the caster according to the present invention.

FIG. 4 is a diagram of the caster when viewed from the side.

FIG. 5 is a diagram of the caster when viewed from the rear side.

FIG. 6 is a diagram illustrating an exploded configuration of the caster.

FIG. 7 is a diagram illustrating an exploded configuration of a restraining part.

FIG. 8 is a diagram of a carrier receiving part of FIG. 1 when viewed from the side, in which a partial cross-section of a body is formed while the caster portion is enlarged.

FIG. 9 is a diagram of a carrier receiving part pressed down or inclined when viewed from the side.

FIGS. 10A, 10B, 10C, and 10D are diagrams schematically illustrating a restraining part and a wheel part to explain the operation of the caster and diagrams illustrating a step-by-step process from a driving mode to a stop mode.

FIGS. 11A, 11B, and 11C are diagrams schematically illustrating a restraining part and a wheel part to explain the operation of the caster and diagrams illustrating a step-by-step process from the stop mode to the driving mode.

### DETAILED DESCRIPTION OF THE INVENTION

In order to fully understand the present invention, preferred embodiments of the present invention will be described with reference to the accompanying drawings. Embodiments of the present invention may be modified in various forms and should not be construed that the scope of the present invention is limited to embodiments to be described below. The embodiments will be provided for more completely explaining the present invention to those skilled in the art. Therefore, the shapes of components in the drawings may be exaggerated to emphasize a more clear description. It should be noted that in each drawing, the same member may be illustrated by the same reference numeral. The detailed description of known functions and configurations that are determined to make the gist of the present invention unnecessarily unclear will be omitted.

Before the description, a caster 10 for a carrier according to the present invention may preferably be mounted and used on a lower surface of a carrier receiving part 20, but may be used for a wagon, a cart, etc. that require a rolling means for moving the luggage, if necessary. In the following description, specific structure and operation for the caster 10 applied to the carrier will be described as an example.

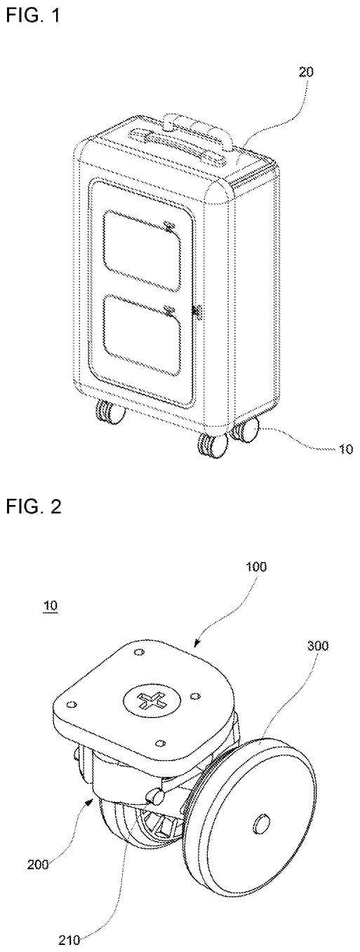

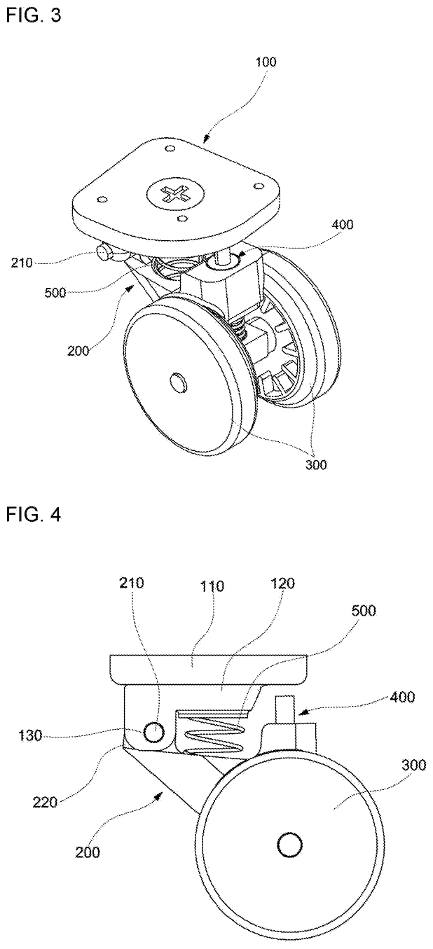

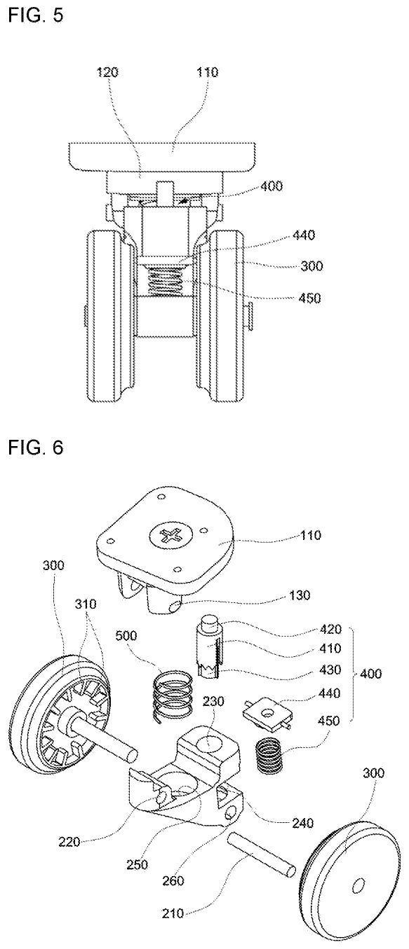

The caster 10 according to the present invention, as illustrated in FIGS. 1 to 6, may be defined to include a base part 100 mounted on a lower surface of the carrier receiving part 20, a body 200 rotatably mounted on the base part 100 based on a rotation shaft 210, a wheel 300 mounted on the body 200, a restraining part 400 mounted on the body 200 and selectively restraining the wheel 300 by pressing by the base part 100 rotated when pressing the carrier receiving part 20 down or inclining the carrier receiving part 20, and a first restoration spring 500 provided between the base part 100 and the body 200 to restore the rotated base part 100 to its original position.

Here, the carrier receiving part 20 refers to a member having a housing shape of forming a receiving space, and a plurality of casters 10 may be mounted on the lower surface of the carrier receiving part 20.

On the other hand, when summarizing the main features of the caster 10 according to the present invention, the caster 10 according to the present invention may be selectively implemented in a driving mode or stop mode by pressing down the carrier receiving part 20 or inclining the carrier receiving part 20 to one side.

For example, in the case where it is necessary to fix the position of the carrier receiving part 20 in the process of moving the carrier receiving part 20, when the carrier receiving part 20 is pressed down or inclined in one direction, the caster 10 becomes to the stop mode to limit the rolling movement of the caster 10. In the state of the stop mode, if the carrier receiving part 20 is inclined in one direction once again, the caster 10 becomes to the driving mode to start the rolling movement of the caster 10.

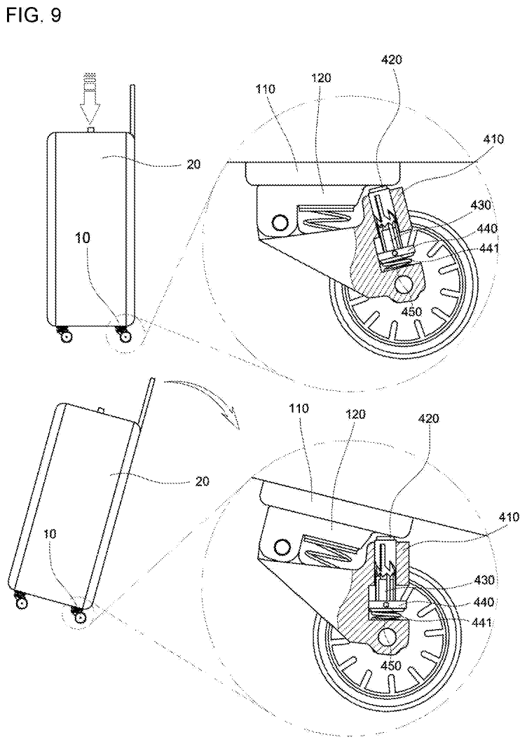

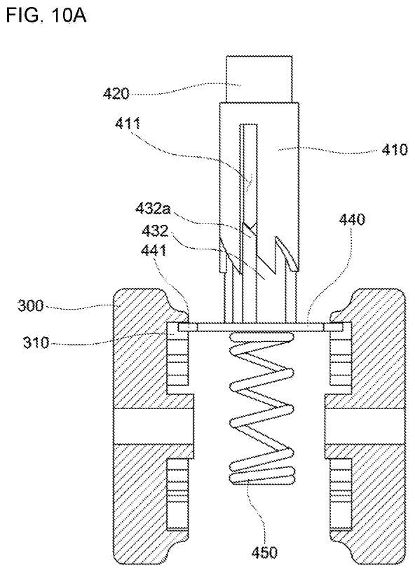

As a configuration for this, first, the base part 100 may be fixedly installed on the lower surface of the carrier receiving part 20 through a fastening member such as a bolt. As illustrated in the bottom of FIG. 9, when the carrier receiving part 20 is inclined in one direction, the base part 100 serves to press the upper end of the restraining part 400 mounted on the body 200 while being inclined in connection thereto.

On the contrary, as illustrated in the top of FIG. 9, when the carrier receiving part 20 is pressed down, it is natural that the body 200 may be rotated relative to the base part 100.

The base part 100 may be exemplified to include a fixing member 110 that is fixedly installed on the lower surface of the carrier receiving part 20 through a fastening means such as bolts, and a rotating member 120 that is rotatably mounted in place below the fixing member 110. A bearing (not illustrated) may be configured to be interposed between the fixing member 110 and the rotating member 120 to assist the relative rotation of the rotating member 120 in the fixing member 110. Through this, the base part 100 enables the posture of the body 200 to be freely rotatable, and thus plays a role of freely assisting the rotation of the carrier receiving part 20 in the moving direction.

In this case, a second shaft mounting hole 130 into which the rotation shaft 210 is inserted may be formed in the rotating member 120, and the body 200 may be rotatably mounted on the base part 100 via the rotation shaft 210 inserted into the second shaft mounting hole 130.

Next, the body 200 supports members such as the wheel 300, the restraining part 400, the first restoration spring 500, and the like.

A first shaft mounting hole 220 in which the rotation shaft 210 is mounted may be formed on one side of the body 200. In this case, the rotation shaft 210 may be mounted through the first shaft mounting hole 220 of the body 200 and the second shaft mounting hole 130 of the rotating member 120 to each other. Through this structure, when the carrier receiving part 20 is pressed down or inclined, the base part 100 and the body 200 have a structure capable of rotating with each other based on the rotation of the rotation shaft 210.

A fixing hole 230 in which the restraining part 400 is mounted may be formed through the upper surface of the other side of the body 200 in upper and lower directions. When the carrier receiving part 20 is pressed down or inclined, the lower surface of the fixing member 110 of the base part 100 has a structure to press the upper end of the restraining part 400 mounted in the fixing hole 230.

An operation space 240 for lifting the restraining part 400 may be formed below the fixing hole 230. The operation space 240 may be formed of an empty space formed when a partial surface of the body 200 is cut off, and the operation space 240 is used as a space in which a restraint plate 440 of the restraining part 400 to be described below is lifted and a second restoration spring 450 operates.

A spring mounting groove 250 in which the lower portion of the first restoration spring 500 is received may be depressed and formed on the upper surface of the body 200 between the first shaft mounting hole 220 and the fixing hole 230.

The upper end of the first restoration spring 500 is fixed to the lower surface of the rotating member 120, and the lower end thereof may absorb an external shock applied vertically to the caster 10 while being received in the spring mounting groove 250. At the same time, the first restoration spring 500 serves to elastically press the base part 100 inclined with respect to the rotation shaft 210 upward to return the base part 100 to its original state and finally move the carrier receiving part 20 inclined to its original state.

A wheel mounting hole 260 may be formed directly under the operation space 240 of the body 200, and a pair of wheels 300 may be mounted on the wheel mounting hole 260 to face each other.

Next, the restraining part 400 may control the rolling state of the wheel 300 whenever pressed by the base part 100. For example, when pressed once, the wheel 300 may be restrained, and when pressed again, the wheel 300 may be rolled and moved by releasing the restraint of the wheel 300.

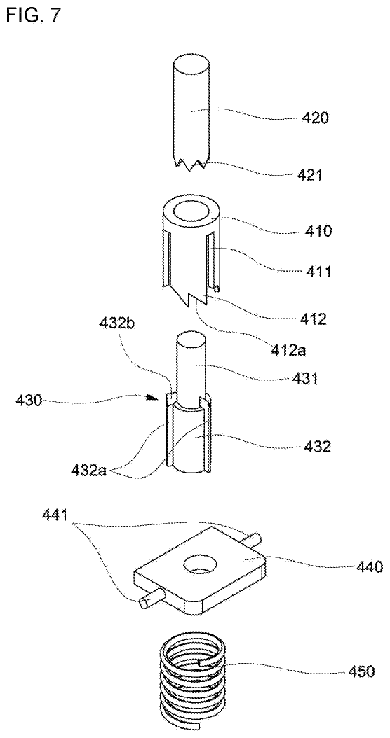

To this end, as illustrated in FIG. 7, the restraining part 400 may be exemplified to include a cylinder 410 fixedly mounted in the fixing hole 230 and having guide grooves 411 formed in upper and lower directions on an inner circumferential surface thereof and first locking teeth 412 formed at a lower end thereof, a push rod 420 which reciprocates upward and downward from the inside of the cylinder 410 while exposed to the upper portion of the cylinder 410 and has second locking teeth 421 formed at a lower end thereof, an operation shaft 430 including an insertion shaft 431 inserted into the push rod 420 and a cam shaft 432 which extends to the lower portion of the insertion shaft 431 and has an operation cam 432a protruding from the outer circumferential surface thereof to be engaged with the first locking teeth 412 or inserted into the guide grooves 411, a restraint plate 440 which is mounted on the lower end of the operation shaft 430 and configured to be selectively locked to the wheel 300 by elevating upward and downward in the operation space 240 by the operation shaft 430, and a second restoration spring 450 which is provided in the operation space 240 to elastically press the restraint plate 440 upward.

First, the cylinder 410 is formed of a hollow type and may be inserted and mounted into the fixing hole 230. A plurality of guide grooves 411 and first locking teeth 412 may be alternately formed with each other with a predetermined angular phase difference. For example, the cylinder 410 may have a structure in which the guide grooves 411 are formed between each group of first locking teeth 412 configured as a pair.

The guide grooves 411 may be illustrated in a form in which the inner circumferential surface of the cylinder 410 is depressed by a predetermined depth or a form that completely penetrates through the outer circumferential surface of the cylinder 410. The first locking teeth 412 may be formed with an inclined surface 412a having a predetermined angle so that the operation cam 432a may be guided.

When the operation cam 432a of the operation shaft 430 moves along the inclined surface 412a of the first locking teeth 412, an angular motion of the operation shaft 430 may occur, and accordingly, the operation cam 432a may be rotated to be engaged between the pair of first locking teeth 412 or inserted into the guide grooves 411.

In other words, when the operation shaft 430 rotates to a position corresponding to a point between the pair of first locking teeth 412, the operation cam 432a is configured so that the upper end of the operation cam 432a are engaged with the first locking teeth 412 to limit the upward movement of the operation shaft 430.

On the contrary, when the operation shaft 430 rotates to a position corresponding to the guide grooves 411, the operation cam 432a may be guided by the guide grooves 411 to allow the upward movement of the operation shaft 430.

The push rod 420 is a portion pressed by the base part 100 and pulls the operation shaft 430 downward in the cylinder 410. When the operation cam 432a moves to a bottom dead point separated from both the first locking teeth 412 and the guide grooves 411 by the push rod 420, the push rod 420 serves to rotate the operation shaft 430 at a predetermined angle.

The push rod 420 is configured to have an open lower end so that the insertion shaft 431 of the operation shaft 430 may be inserted therein, and the operation cam 432a of the cam shaft 432 may be in sliding contact with the second locking teeth 421.

When the push rod 420 is pressed, the second locking teeth 421 press the operation cam 432a to allow the operation shaft 430 to move downward. At this time, when the operation cam 432a is engaged with the first engaging teeth 412, the operation cam 432a is separated from the first locking teeth 412, and when the operation cam 432a is inserted into the guide grooves 411, the operation cam 432a is removed from the guide grooves 411 to move to the bottom dead point.

In addition, at the bottom dead point of the operation shaft 430, the operation cam 432a slides on the second locking teeth 421, so that the operation shaft 430 may be rotated at a predetermined angle.

Next, the operation shaft 430 controls the position of the restraint plate 440 mounted at the lower end by interlocking with the pressing action of the push rod 420. At this time, it is preferred that the operation shaft 430 is configured so as to turn away from the restraint plate 440.

The operation shaft 430 is locked to the first locking teeth 412 of the cylinder 410 to limit the upward movement, or is configured to ascend along the guide grooves 411 of the cylinder 410 to determine the upper and lower positions of the restraint plate 440.

The insertion shaft 431 and the cam shaft 432 constituting the operation shaft 430 may be formed coaxially with each other. On the outer circumferential surface of the cam shaft 432, the operation cam 432a may be formed to protrude upward and downward, and a plurality of operation cams 432a may be arranged at equal intervals along the circumferential direction of the cam shaft 432.

The upper end of the operation cam 432a is configured to be inclined at a predetermined angle so as to be in sliding contact with the first locking teeth 412 and the second locking teeth 421, and particularly, the operation cam 432a may have an inclined surface 432b having the same angle as the inclined surface 412a of the first locking teeth 412. In addition, the restraint plate 440 may be fixedly mounted on the lower end of the cam shaft 432.

The restraint plate 440 is interlocked with the lifting operation shaft 430 to restrain the rolling of the wheel 300 in the operation space 240.

On the other hand, a plurality of spokes 310 are formed at equal intervals on an inner ring of the wheel 300 and the restraint plate 440 may have a locking protrusion 441 protruding to be selectively inserted into a point between adjacent spokes 310. At this time, the spokes 310 are formed to extend a predetermined distance from the inner ring of the wheel 300 toward the center of the wheel 300 so as to be spaced apart from the center of the wheel 300 at a predetermined distance and configured to be not locked to the locking protrusion 441 when the restraint plate 440 descends.

The second restoration spring 450 elastically presses the restraint plate 440 upwardly from the lower side of the restraint plate 440, and the operation shaft 430 may be elastically pulled upward by the elastic pressing force.

When the operation cam 432a is inserted into the guide grooves 411, the operation shaft 430 may be moved to a top dead point by the elastic pressing force of the second restoration spring 450. Accordingly, the push rod 420 may also be moved upward.

Hereinafter, the operation of the caster 10 according to the present invention will be described with reference to the accompanying drawings. In this operation, a process of converting the driving mode or the stop mode of the caster 10 according to the pressing or inclining of the carrier receiving part 20 will be described as an example.

Before the description, the driving mode of the caster 10 means a state in which the wheel 300 of the caster 10 may be rolled, and the stop mode means a state in which the wheel 300 is locked to the locking protrusion 441 of the restraint plate 440 so as not to be rolled.

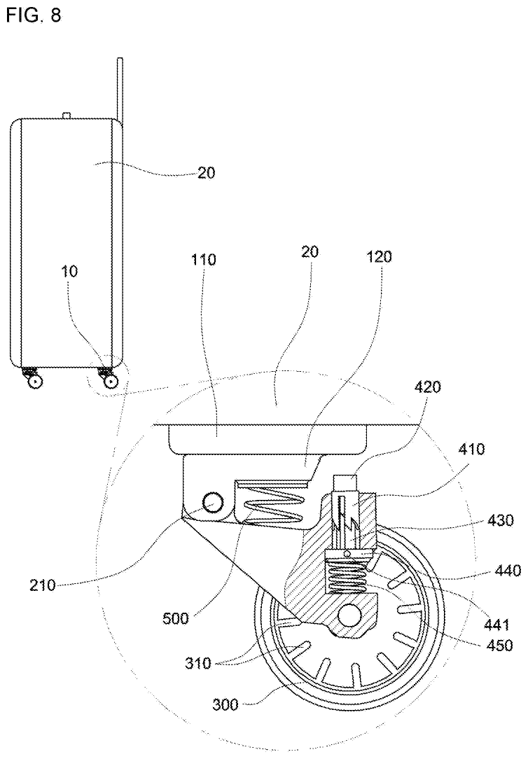

First, when the position of the carrier receiving part 20 is requested to be fixed in the driving mode of the caster 10, the carrier receiving part 20 in the state illustrated in FIG. 8 is pressed down or inclined as illustrated in FIG. 9.

When the carrier receiving part 20 is pressed down or inclined, the base part 100 is rotated with respect to the rotation shaft 210 to press the push rod 420 once.

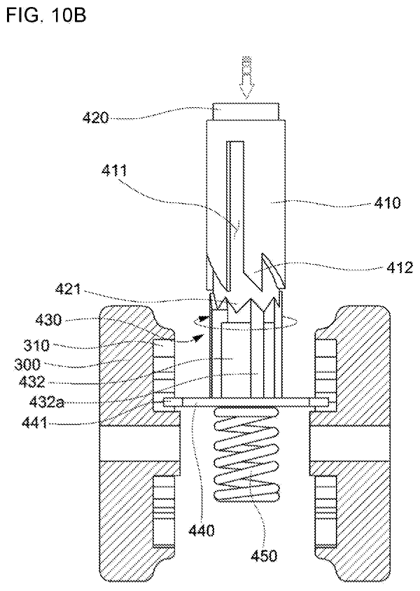

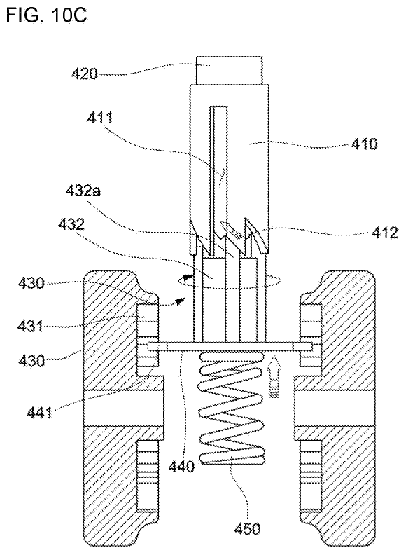

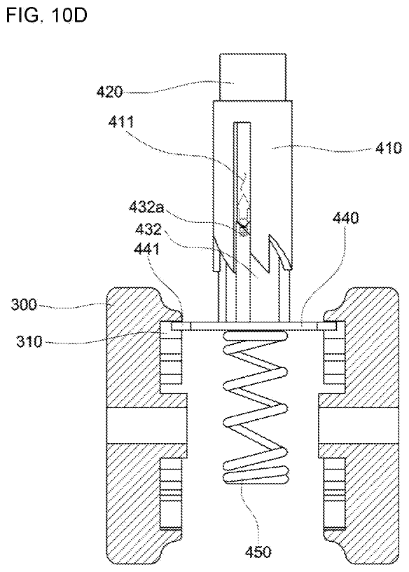

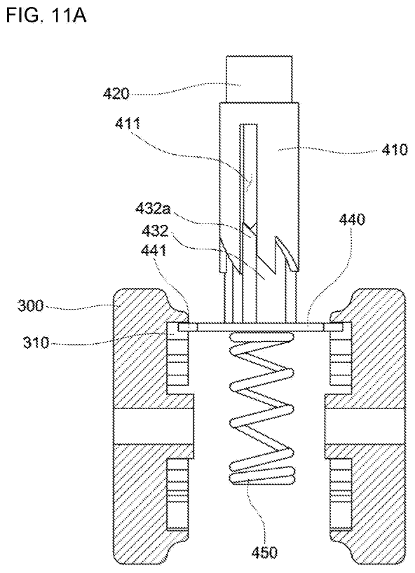

When the push rod 420 is pressed in the state illustrated in FIG. 10A, the operation shaft 430, which has been engaged with the first locking teeth 412 to limit the upward movement, descends along the downward movement of the push rod 420 as illustrated in FIG. 10B to move to a bottom dead point. At the bottom dead point of the operation shaft 430, the operation cam 432a slides and rotates from the second locking teeth 421, so that the operation shaft 430 rotates at a predetermined angle to guide the operation cam 432a to the guide grooves 411.

When the carrier receiving part 20 in the state illustrated in FIG. 9 is restored to its original state illustrated in FIG. 8 by the elastic restoring force of the first restoration spring 500, the restraint plate 440 and the operation shaft 430 ascend by the elastic pressing force of the second restoration spring 450. At this time, as illustrated in FIG. 10C, while the inclined surface 432b of the operation cam 432a is guided to the inclined surface 412a of the first locking teeth 412, the operation cam 432a is guided to the guide grooves 411 and ascends. Finally, as illustrated in FIG. 10D, the locking protrusion 441 of the restraint plate 440 is interposed at a point between the adjacent spokes 310, so that the wheel 300 becomes to the stop mode in which the wheel cannot be rolled.

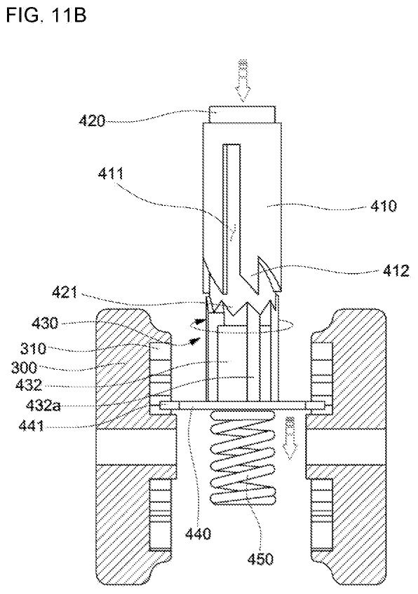

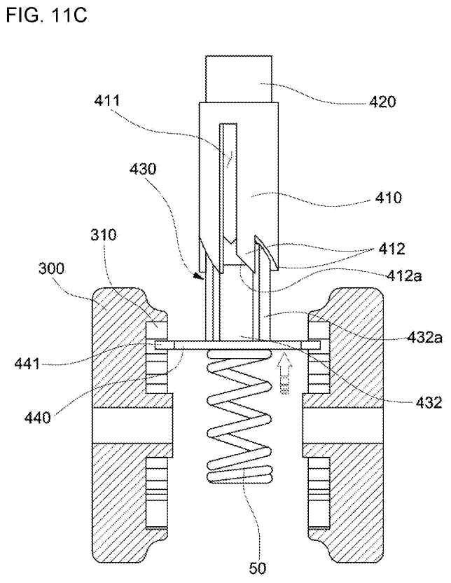

In the case of converting the state from the stop mode to the driving mode again, when the push rod 420 is pressed in the state (stop mode) illustrated in FIG. 11A as the carrier receiving part 20 is pressed again or inclined, as illustrated in FIG. 11B, the operation shaft 430 descends in connection with this, and then the operation cam 432a slides and rotates from the second locking teeth 421, and the operation shaft 430 rotates at a predetermined angle, so that the operation cam 432a may be guided between a pair of first locking teeth 412 disposed alternately with the guide grooves 411.

When the carrier receiving part 20 in the state illustrated in FIG. 9 is restored to its original state illustrated in FIG. 8 by the elastic restoring force of the first restoration spring 500, the restraint plate 440 and the operation shaft 430 ascend by the elastic pressing force of the second restoration spring 450. At this time, as illustrated in FIG. 11C, the operation cam 432a is engaged between the pair of first locking teeth 412 adjacent to each other to limit the upward movement of the operation shaft 430. Finally, while the upward movement of the operation shaft 430 and the restraint plate 440 is limited, the locking protrusion 441 of the restraint plate 440 is separated from a point between the adjacent spokes 310, so that the wheel 300 becomes to the driving mode in which the wheel can be rolled.

In summary, the caster 10 according to the present invention provides effects capable of more easily operating the caster 10 and further more easily handling the carrier receiving part 20 by simply pressing the carrier receiving part 20 with a hand or inclining the carrier receiving part to press the restraining part 400 of the caster 10 so as to selectively drive a driving mode or a stop mode of the caster 10, without pressing a lever installed around the wheel 300 with a foot or removing the wheel 300 itself from the carrier to control a rolling condition of the wheel 300 like the caster 10 in the related art.

The embodiments of the present invention described above are merely exemplary, and those skilled in the art to which the present invention pertains will appreciate that various modifications and other equivalent embodiments are possible. Therefore, it will be appreciated that the present invention is not limited only to the form mentioned in the detailed description above. Therefore, the true technical scope of the present invention should be defined by the technical spirit of the appended claims. In addition, it is to be understood that the present invention includes the spirit of the present invention as defined by the appended claims and all modifications, equivalents and substitutes within the scope thereof.

### Explanation of Reference Numerals and Symbols

100: Base part
200: Body
300: Wheel
400: Restraining part
500: First restoration spring

1. A caster for a carrier mounted on a lower surface of a carrier receiving part, the caster comprising:
a base part mounted on a lower surface of the carrier receiving part;
a body rotatably mounted on the base part based on a rotation shaft;
a wheel mounted on the body;
a restraining part mounted on the body and selectively restraining the wheel by pressing by the base part rotated when pressing the carrier receiving part down or inclining the carrier receiving part; and
a first restoration spring provided between the base part and the body to restore the rotated base part to its original position,
wherein a first shaft mounting hole in which the rotation shaft is mounted is formed in one side of the body and a fixing hole in which the restraining part is mounted is formed in an upper surface of the other side of the body.

2. The caster of claim 1, wherein a spring mounting groove in which a lower portion of the first restoration spring is received is depressed and formed on the upper surface between the first shaft mounting hole and the fixing hole.

3. The caster of claim 2, wherein in the lower portion of the fixing hole, an operation space for lifting a restraint plate is formed.

4. The caster of claim 3, wherein the restraining part comprises:
a cylinder fixedly mounted in the fixing hole and having guide grooves formed in upper and lower directions on an inner circumferential surface thereof and first locking teeth formed at a lower end thereof;
a push rod which reciprocates upward and downward from the inside of the cylinder while exposed to the upper portion of the cylinder and has second locking teeth formed at a lower end thereof;
an operation shaft including an insertion shaft inserted into the push rod and a cam shaft which extends to the lower portion of the insertion shaft and has an operation cam protruding from the outer circumferential surface thereof to be engaged with the first locking teeth or inserted into the guide groove;
a restraint plate which is mounted on the lower end of the operation shaft and configured to be selectively locked to the wheel by elevating upward and downward in the operation space by the operation shaft; and
a second restoration spring which is provided in the operation space to elastically press the restraint plate upward.

5. The caster of claim 4, wherein a plurality of spokes are formed at equal intervals on an inner ring of the wheel and the restraint plate has a locking protrusion protruding to be selectively inserted into a point between adjacent spokes.
